(19) United States
(12) Patent Application Publication
(10) Pub. No.: US 2011/0206068 A1
(43) Pub. Date: Aug. 25, 2011

(54) OPTICAL FIBER EMISSION CIRCUIT AND FIBER LASER

(75) Inventor: Hironori Tanaka, Sakura-shi (JP)

(73) Assignee: FUJIKURA LTD., Tokyo (JP)

(21) Appl. No.: 12/962,837

(22) Filed: Dec. 8, 2010

(30) Foreign Application Priority Data
Dec. 14, 2009 (JP) 2009-282387

(51) Int. Cl. H01S 3/30; G02B 6/32

(52) U.S. Cl. 372/6; 385/33

(57) ABSTRACT

Object An object of the present invention is to reuse unavailable excitation light without deteriorating reliability of a fiber laser.

Solving Means An optical fiber emission circuit according to the present invention includes a rare earth-doped optical fiber 11 that has a first clad 22 including a plurality of layers of clads around a core 21 and emits radiation light having a wavelength longer than a wavelength of excitation light when the excitation light is made incident thereto, and a GRIN lens 12 that is fuse-bonded to an end face of the rare earth-doped optical fiber and has a refractive index distribution in a radial direction. The GRIN lens 12 has a lens length that is a value except for an integer multiple of 0.5 pitch and is provided with a reflection filter 24 that is disposed at an open end part in an axial direction and selectively reflects the wavelength of the excitation light.

### TECHNICAL FIELD

The present invention relates to fiber laser emission circuits using a rare earth-doped optical fiber and fiber lasers provided with the fiber laser emission circuits, and particularly, to a fiber laser emission circuit and a fiber laser that reuses unavailable excitation light from a rare earth-doped optical fiber.

### BACKGROUND ART

A fiber laser using a double clad fiber (DCF) that amplifies light by propagating excitation light to a clad around a core has been used. In the clad excitation structure, an inverted distribution is not formed in a rare earth element when excitation light intensity in the clad is reduced to a certain density. Therefore, light-light conversion efficiency is undesirably reduced due to reversal of a balance between a gain and absorption of the amplified light propagating the core.

Technologies for preventing the reduction in conversion efficiency have been proposed. For example, in a first conventional example, a multilayer mirror for selectively reflecting excitation light in a DCF is provided at a leading end of the DCF (see Patent Document 1, for example). In a second conventional example, an optical fiber is wound around a transparent circular plate, and a member for reflecting excitation light is disposed on an outer periphery (see Patent Document 2, for example). As explained above, the reduction in light-light conversion efficiency conventionally has been prevented by directly reflecting the excitation light after propagating through the DCF and causing the reflected light to enter the DCF again.

### RELATED ART DOCUMENTS

### Patent Documents

Patent Document 1 Japanese Patent Application Laid-Open No. 11-121836
Patent Document 2 Japanese Patent Application Laid-Open No. 2007-115968

### DISCLOSURE OF THE INVENTION

### Problems to be Solved by the Invention

However, in the first conventional example, the amplified light enters the multilayer mirror. Therefore, there has been a possibility of damage to the multilayer mirror in the case where the amplified light has high intensity.

In contrast, in the second conventional example, the excitation light is introduced into the DCF through a coating of the optical fiber. A transparent resin such as acryl is used for the coating of the optical fiber in the second conventional example, but the transparent resin has a lower high power resistance as compared to silica included in components of the optical fiber. Therefore, there is a possibility of burnout of the transparent resin, resulting in inferior reliability.

In view of the above, an object of the present invention is to reuse unavailable excitation light without deteriorating reliability of a fiber laser.

### Means for Solving the Problems

In order to solve the problem described above, it is characteristic of an optical fiber emission circuit according to the present invitation to include: a rare earth-doped optical fiber that has a plurality of layers of clads around a core and emits radiation light having a wavelength longer than a wavelength of excitation light when the excitation light is made incident thereto and a GRIN (Graded-Index) lens that is fuse-bonded to an end face of the rare earth-doped optical fiber and has a refractive index distribution in a radial direction, wherein the GRIN lens has a lens length that is a value except for an integer multiple of 0.5 pitch and is provided with a reflection filter that is disposed at an open end part in an axial direction and selectively reflects the wavelength of the excitation light.

Excitation light that enters a graded-index (GRIN) lens from a clad of a rare earth-doped optical fiber is reflected by a reflection filter. Here, the excitation light reciprocates in the GRIN lens to enter the clad of the rare earth-doped optical fiber again. Thus, it is possible to efficiently reuse the excitation light. Also, since it is possible to prevent emission to a layer that does not allow transmission of the excitation light in the rare earth-doped optical fiber, it is possible to prevent heating otherwise caused at a boundary between the rare earth-doped optical fiber and the GRIN lens and a damage caused by the heating.

After entering the GRIN lens, the amplified light having an emission diameter corresponding to a lens length is emitted from an emission end of the GRIN lens. Here, since the lens length is a value except for an integer multiple of 0.5 pitch, it is possible to alleviate a power density difference of the amplified light in the reflection filter. Thus, it is possible to prevent a damage otherwise caused on the reflection filter by the amplified light.

Since the GRIN lens is fuse-connected to the leading end of the rare earth-doped optical fiber, a connection loss between the rare earth-doped optical fiber and the GRIN lens is reduced. Thus, it is possible to improve use efficiency of the amplified light and the excitation light. It is also possible to prevent heating otherwise caused at a boundary between the rare earth-doped optical fiber and the GRIN lens and a damage caused by the heating.

Therefore, the optical fiber emission circuit according to the present invention may reuse the unavailable excitation light without deteriorating reliability of the fiber laser.

In the optical fiber emission circuit according to the present invention, the lens length of the GRIN lens is preferably within a range of an odd multiple of 0.25 pitch ±0.15 pitch.

According to the present invention, it is possible to keep a power density of the amplified light in the reflection filter to about 1/10 of that generated in the case of 0.5 pitch.

In the optical fiber emission circuit according to the present invention, a sectional shape of a first clad among the plurality of layers of clads contacting the core is preferably an irregular polygon having L angles (L is an integer that is equal to or larger than 3) or a regular polygon having M angles (M is an odd number that is equal to or larger than 3).

In the optical fiber emission circuit according to the present invention, a sectional shape of a first clad among the plurality of layers of clads contacting the core is preferably a regular polygon having N angles (N is an even number that is equal to or larger than 4), and the GRIN lens has a lens length that is a value except for an integer multiple of 1/N of 0.5 pitch.

According to the present invention, it is possible to cause the excitation light that has propagated in the rare earth-doped optical fiber as light in a skew mode to enter the clad of the rare earth-doped optical fiber after converting the excitation light into a propagation state that facilitates combination with the core.

In the optical fiber emission circuit according to the present invention, the lens length of the GRIN lens is preferably within a range of an odd multiple of 0.25 pitch ±0.03 pitch.

According to the present invention, it is possible to improve coupling efficiency of the excitation light reflected by the reflection filter with the rare earth-doped optical fiber.

In the optical fiber emission circuit according to the present invention, the lens length of the GRIN lens is preferably within a range of an odd multiple of 0.25 pitch ±0.02 pitch.

According to the present invention, it is possible to cause the light emitted from the GRIN lens to efficiently propagate through a long distance space as collimate light.

It is characteristic of a fiber laser according to the present invention to include: the optical fiber emission circuit according to the present invention; an excitation light source that supplies the excitation light to the optical fiber emission circuit; and a pair of reflection mirrors that are disposed at two distant points in the rare earth-doped optical fiber and generates laser oscillation of the excitation light from the excitation light source.

According to the present invention, it is possible to provide a fiber laser that reuses the unavailable excitation light without deteriorating reliability.

### Effect of the Invention

According to the present invention, it is possible to reuse unavailable excitation light without deteriorating reliability of a fiber laser.

### BRIEF DESCRIPTION OF THE DRAWINGS

FIG. 1 is a block diagram schematically showing a fiber laser according to the present embodiment.

FIG. 2 is a block diagram schematically showing an optical fiber emission circuit according to the present embodiment.

FIGS. 3(a) to 3(b) are diagrams showing examples of a propagation path of light in a skew mode, and 3(a) is the case in which reflection occurs once at each of sides of a first clad, and 3(b) is the case in which reflection occurs twice at each of the sides of the first clad.

FIGS. 4(a) to 4(d) are first examples of a propagation path of light in skew mode in the case where a sectional shape of the first clad is a regular polygon having M angles (M is an odd number that is equal to or larger than 3), and 4(a) shows the propagation path before entering a GRIN lens, and 4(b) shows the propagation path after entering a GRIN lens having a lens length which is shorter than an odd multiple of 0.25 pitch, and 4(c) shows the propagation path after entering a GRIN lens having a lens length which is the odd multiple of 0.25 pitch, and 4(d) shows the propagation path after entering a GRIN lens having a lens length which is longer than the odd multiple of 0.25 pitch.

FIGS. 5(a) to 5(d) are second examples of a propagation path of light in skew mode in the case where a sectional shape of the first clad is a regular polygon having N angles (N is an even number that is equal to or larger than 4), and 5(a) shows the propagation path before entering a GRIN lens, and 5(b) shows the propagation path after entering a GRIN lens having a lens length which is shorter than an odd multiple of 0.25 pitch, and 5(c) shows the propagation path after entering a GRIN lens having a lens length which is the odd multiple of 0.25 pitch, and 5(d) shows the propagation path after entering a GRIN lens having a lens length which is longer than the odd multiple of 0.25 pitch.

### BEST MODE FOR CARRYING OUT THE INVENTION

Embodiments of the present invention will be described with reference to the accompanying drawings. The embodiments described below are not more than one example of configuration of the present invention, and the present invention is not limited to the following embodiment.

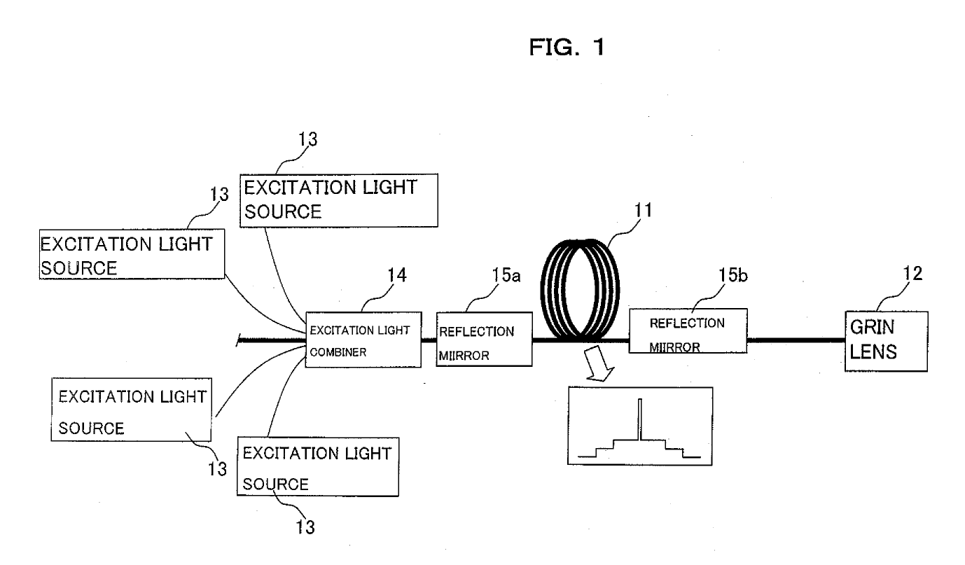

FIG. 1 is a block diagram schematically showing a fiber laser according to the present embodiment. The fiber laser according to the present embodiment is provided with a rare earth-doped optical fiber 11, a GRIN lens 12, and a plurality of excitation light sources 13, and an excitation light combiner 14, and a pair of reflection mirrors 15a and 15b. The rare earth-doped optical fiber 11 and the GRIN lens 12 form an optical fiber emission circuit.

The plurality of excitation light sources 13 supply excitation light of a rare earth element to the rare earth-doped optical fiber 11. The excitation light combiner 14 combines the excitation light emitted from the plurality of light sources 13 with a first clad of the rare earth-doped optical fiber 11. The excitation light propagating through the first clad of the rare earth-doped optical fiber 11 is absorbed by a rare earth ion when passing through a core, and radiation light having a wavelength longer than the excitation light is radiated from the rare earth ion. The excitation light and a part of the radiation light are reflected by the reflection mirror 15a and the reflection mirror 15b disposed at opposite ends of the rare earth-doped optical fiber 11 to cause laser oscillation. Here, the radiation light is amplified by the rare earth-doped optical fiber 11 by the induction discharge phenomenon. A part of the light of laser oscillation propagates through the reflection mirror 15b and is outputted from the GRIN lens 12 connected to the reflection mirror 15b via an optical fiber.

Here, the reflection mirrors 15a and 15b are of a fiber brag grating, for example. Though the example, wherein the reflection mirrors 15a and 15b are disposed at the opposite ends of the rare earth-doped optical fiber 11 is shown in FIG. 1, it is sufficient insofar as the reflection mirrors 15a and 15b are disposed at the distant two points. Also, though the example wherein the optical fiber is connected between the reflection mirror 15b and the GRIN lens 12 is shown, the example is not limitative. For example, the reflection mirror 15b may directly connect with the GRIN lens 12, or another optical member may be connected between the reflection mirror 15b and the GRIN lens 12.

Then, in the optical fiber emission circuit shown in FIG. 1, it is necessary to set a reflection ratio of the reflection mirror 15b to a value higher than a reflection ratio of the reflection filter at the GRIN lens 12 in order to form the oscillator shown in FIG. 1 between the reflection mirror 15a and the reflection mirror 15b without failing. A method of directly forming a reflection filter that selectively reflects the excitation light at a beam emission end of the rare earth-doped optical fiber 11 without using the GRIN lens 12 may be considered. However, since such method may not attain beam diameter enlargement effect by the GRIN lens 12, there is a possibility of burnout of the reflection filter due to an increase in power density of the amplified light propagating through the reflection filter. Therefore, it is possible to prevent the burnout of the reflection filter by enlarging the beam diameter of the amplified light by connecting the GRIN lens 12 in which the reflection filter is provided at the emission end.

The fiber laser according to the present embodiment is provided with the optical fiber emission circuit provided with the rare earth-doped optical fiber 11 and the GRIN lens 12, therefore, the fiber laser may reuse the unavailable excitation light from a tail end part of the rare earth-doped optical fiber 11, improve the light-light conversion efficiency, and reduce adverse influences such as a reduction of life and burnout of a component part otherwise caused by heating. Hereinafter, details of the optical fiber emission circuit will be described.

A simple experiment was conducted for the purpose of confirming counter power characteristics of a reflection filter formed of a dielectric multilayer film by providing the reflection filter at a beam emission end of a commonly used optical fiber. Burnout of the reflection filter occurred with high probability under the condition where an average intensity of single mode light is 75 kW/mm² while it was possible to reduce the reflection filter burnout probability to a several percentages or less by reducing the average intensity to 15 kW/mm². It is considered that it is possible to prevent almost all of burnout of the reflection filter that is caused by high energy light by maintaining the average intensity preferably to 7.5 kW/mm² or less, though it depends on film formation conditions of the reflection filter and use conditions of the laser.

In order to maintain the power density of the amplified light to 1/10 or less at the beam emission end, it is necessary to set the beam diameter of the amplified light at the emission end of the GRIN lens 12 to 3.5 times or more of the beam diameter of the amplified light at the entrance end of the GRIN lens 12. In the case of using a GRIN lens capable of enlarging amplified light to 10 times of the amplified light with the lens length of 0.25 under the condition where average intensity of the amplified light is 75 kW/mm², it is calculated that it is sufficiently possible to prevent end face burnout when the lens length is within a range of 0.1 to 0.4 pitch. Even in the case of using a GRIN lens capable of ×5-enlargement, it is calculated that it is possible to prevent the end face burnout within a range of 0.15 to 0.35 pitch.

Particularly, since the diameter of the entering light is enlarged at a region where the lens length of the GRIN lens 12 is close to an odd multiple of 0.25 pitch, it is possible to reduce the power density of the amplified light at the end part as compared to the configuration of outputting a laser directly from the rare earth-doped optical fiber 11. Therefore, it is possible to largely reduce the probability of the end face burnout that is caused by high intensity light.

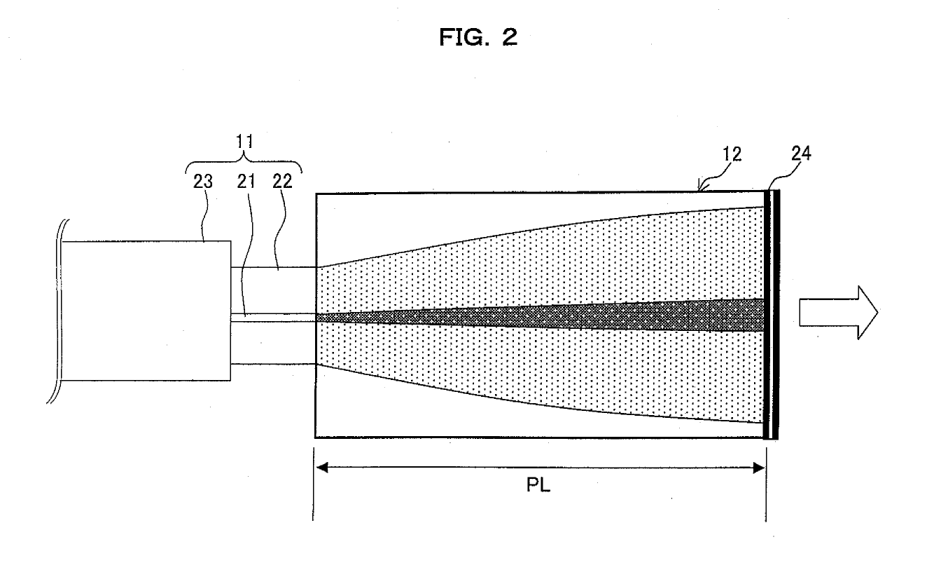

FIG. 2 is a block diagram schematically showing the optical fiber emission circuit according to the present embodiment. Since a rare earth element is contained in a core 21 of the rare earth-doped optical fiber 11, the rare earth-doped optical fiber 11 is capable of emitting radiation light having a wavelength longer than excitation light when the excitation light enters. For example, the rare earth element is Yb. A clad around the core 21 includes a plurality of layers in order to establish a waveguide structure of the clad. In FIG. 2, only a first clad 22 contacting the core among the plurality of layers of clads is shown for brevity. The clad between the first clad 22 and a coating 23 may be one layer or two or more layers. When the clad between the first clad 22 and the coating 23 is one layer, the rare earth-doped optical fiber 11 is a double clad fiber provided with the first clad 22 and a second clad.

The GRIN lens 12 has a refractive index distribution in a radial direction. Therefore, it is possible to set a beam diameter and an emission angle of amplified light to be emitted from the GRIN lens 12 by adjusting a lens length PL. For example, when the lens length PL is an odd multiple of 0.25 pitch, it is possible to enlarge the beam diameter of the amplified light to emit the amplified light as collimate light. When the lens length PL is an even multiple of 0.5 pitch, it is possible to concentrate the beam diameter of the amplified light to be identical to a beam diameter of the entering light.

The GRIN lens 12 is fuse-bonded to an end face of the rare earth-doped optical fiber 11. The parts that are more subject to damage in an optical circuit ordinarily are the end parts that are disconnection points in the optical circuit. Among the end parts, the part that is most subject to damage is an emission end at which a power density of the amplified light is maximized, and the mission end is the end face of the rare earth-doped optical fiber 11 in FIG. 2. By fuse-bonding the GRIN lens 12 to the end face of the rare earth-doped optical fiber 11 which is the most subject to damage, the disconnection point in the optical circuit is eliminated to enable a large reduction in probability of damage caused by high intensity light, thereby making it possible to improve reliability of the optical circuit. The fuse-bonding of the GRIN lens 12 and the rare earth-doped optical fiber 11 is not limited to the direct bonding of the GRIN lens 12 and the rare earth-doped optical fiber 11, and an optical component part such as a filter may be disposed between the GRIN lens 12 and the rare earth-doped optical fiber 11.

In order to eliminate the disconnection point in the optical circuit, it is preferable to use an identical material for the GRIN lens 12 and the rare earth-doped optical fiber 11. In this case, since a heat expansion ratio difference between the GRIN lens 12 and the rare earth-doped optical fiber 11 is eliminated, it is possible to easily perform the fuse-bonding as compared to fuse-boding between different materials.

The GRIN lens 12 is provided with a reflection filter 24 that is disposed at an open end part in an axial direction and selectively reflects a wavelength of the excitation light. Since the reflection filter 24 reflects the excitation light, it is possible to cause unavailable excitation light emitted from the rare earth-doped optical fiber 11 to enter again the rare earth-doped optical fiber 11. And the reflection filter 24 allows amplified light (signal light) to transmit therethrough so that the amplified light (signal light) is emitted from the open end part in the axial direction. Here, since the amplified light has a wavelength that is longer than that of the excitation light, the reflection filter 24 may be a long wavelength transmitting filter that allows a light component having a wavelength that is longer than a specific wavelength to transmit therethrough and reflects a light component of a shorter wavelength. Specific examples of the reflection filter 24 include a dielectric multilayer film.

A fiber laser using the rare earth-doped optical fiber 11 as an amplification fiber usually has a configuration of amplifying light of 1060 nm to 1100 nm by using laser diodes (LD) having wavelengths of 915 nm, 940 nm, and 976 nm as excitation light sources. Therefore, it is preferable that the reflection filter 24 disposed at the end face of the GRIN lens 12 has characteristics of reflecting light having a wavelength shorter than 990 nm and allowing light having a wavelength longer than 1040 nm to transmit therethrough. Thus, it is possible to attain the characteristics of allowing the amplified light to transmit therethrough and reflecting the unavailable excitation light.

In the present embodiment, a minimal diameter of the GRIN lens 12 depends on the number of apertures (NA) of the rare earth-doped optical fiber 11 and a diameter of the first clad 22, and it is necessary to use the GRIN lens 12 that has a NA that is larger than a NA of the first clad 22 of the rare earth-doped optical fiber 11.

The GRIN lens 12 may preferably have a lens length PL which is a value except for an integer multiple of 0.5 pitch. In the case where the lens length PL of the GRIN lens 12 is the integer multiple of 0.5 pitch, the amplified light converges on an optical axis at a position of the reflection filter 24. When high output amplified light is emitted in this state, there is the possibility of damage of the reflection filter 24. Therefore, it is possible to prevent the damage on the reflection filter 24 by setting the lens length PL to the lens length that is a value except for the integer multiple of 0.5 pitch.

More specifically, the lens length PL of the GRIN lens 12 may preferably be within a range of an odd multiple of 0.25 pitch ±0.15 pitch. By setting the lens length to 0.1 pitch or more and 0.4 pitch or less, it is possible to maintain a power density of the amplified light at the reflection filter 24 to 1/10 of a power density when the lens length PL is 0.5 pitch.

When taking coupling efficiency between the excitation light reflected by the reflection filter and the rare earth-doped optical fiber 11 into consideration, the best coupling efficiency is attained when the lens length PL of the GRIN lens 12 is the odd multiple of 0.25 pitch. Accordingly, when considering coupling efficiency of about 90% as an actual range, the lens length PL of the GRIN lens 12 may preferably be within a range of an odd multiple of 0.25 pitch ±0.03 pitch.

Also, the lens length PL may preferably be within a range that is a little longer than the odd multiple of 0.25, more specifically within a range of an odd multiple of 0.25 pitch ±0.02 pitch. Since it is possible to cause the emitted light to efficiently propagate through a long distance space as the collimate light with the lens length PL, it is unnecessary to provide a collimate lens, and it is possible to attain the prevention of end face damage and the role of collimator by using one component part.

Hereinafter, a lens length of the GRIN lens 12 that is set with respect to a sectional shape of the first clad 22 of the rare earth-doped optical fiber 11 for the purpose of a reduction of skew mode light will be described.

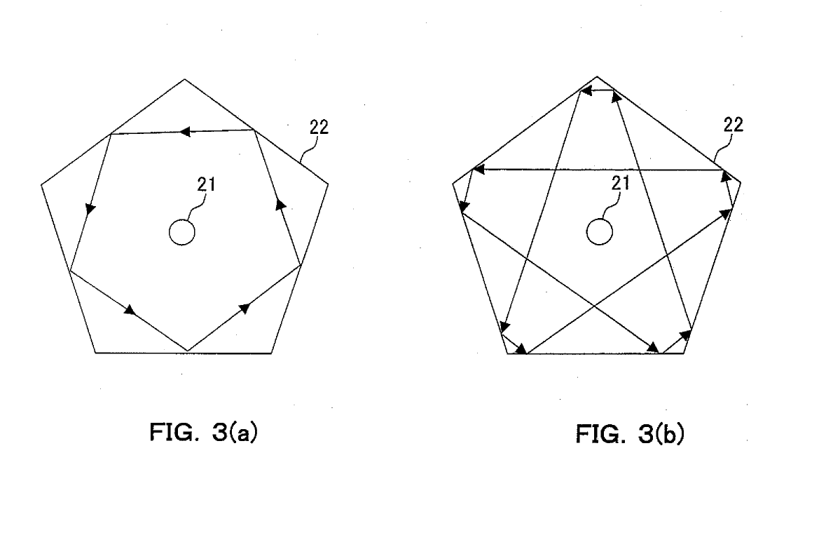

Shown in FIGS. 3(a) and 3(b) are diagrams of one example of propagation path of the skew mode light in the case where the sectional shape of the first clad is pentagon-shaped. Shown in FIG. 3(a) is the case in which the skew mode light is reflected once at each of sides of the first clad, and shown in FIG. 3(b) is the case in which the skew mode light is reflected twice at each of the sides of the first clad. In the case of combination with the skew mode, almost all of the excitation light does not pass through the core and is propagated to the emission end of the rare earth-doped optical fiber without being absorbed by the rare earth element with which the core 21 is doped. Therefore, the GRIN lens 12 shown in FIG. 2 may preferably convert the excitation light propagated in the rare earth-doped optical fiber as the skew mode light into a propagation state that is readily combined with the core 21 and cause the excitation light in the propagation state to enter the first clad 22 of the rare earth-doped optical fiber. Thus, it is possible to reuse the unavailable excitation light.

In the GRIN lens 12 shown in FIG. 2, the skew mode light reduction effect is varied depending on a sectional shape of the first clad 22 to be used. For example, in the case where the sectional shape of the first clad 22 is an irregular polygon having L angles (L is an integer that is equal to or larger than 3) or a regular polygon having M angles (M is an odd number that is equal to or larger than 3), the reflected unavailable excitation light is combined with the skew mode when the lens length PL of the GRIN lens 12 is an integer multiple of 0.5 pitch. Therefore, it is possible to reduce the skew mode light by avoiding the lens length PL which is the integer multiple of 0.5 pitch.

In contrast, in the case where the sectional shape of the first clad 22 is a regular polygon having N angles (N is an even number that is equal to or larger than 4), the reflected unavailable excitation light is also combined with the skew mode when the lens length PL of the GRIN lens 12 is a multiple of 1/N of 0.5 pitch. Therefore, it is possible to reduce the skew mode light by avoiding the lens length PL that is an integer multiple of 1/N of 0.5 pitch.

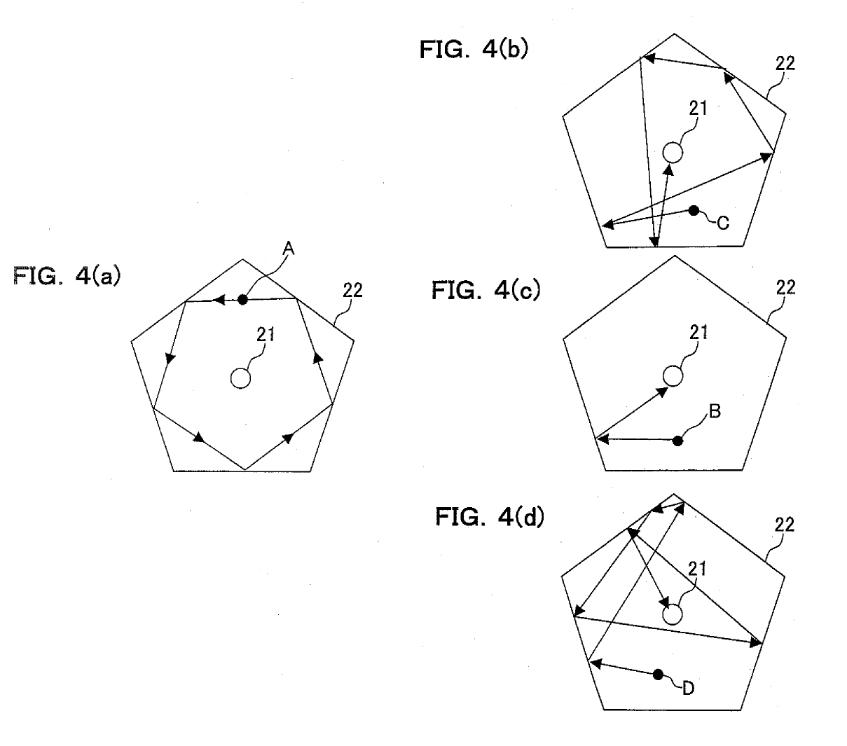

Shown in FIGS. 4(a) to 4(d) are diagrams of a first example of a propagation path of light in skew mode in the case where a sectional shape of the first clad is a regular polygon having M angles (M is an odd number that is equal to or larger than 3), wherein FIG. 4(a) is the propagation path before entering a GRIN lens, FIG. 4(b) is the propagation path after entering a GRIN lens having a lens length which is shorter than an odd multiple of 0.25 pitch, FIG. 4(c) is the propagation path after entering a GRIN lens having a lens length which is the odd multiple of 0.25 pitch, and FIG. 4(d) is the propagation path after entering a GRIN lens having a lens length which is longer than the odd multiple of 0.25 pitch. In FIG. 4, the case in which the sectional shape is a regular pentagon-shaped, i.e. M=5, is shown as one example of the regular polygon having M angles.

The skew mode excitation light that has propagated clockwise enters the GRIN lens from a point A shown in FIG. 4(a). Here, in the case where the lens length of the GRIN lens is 0.5 pitch, the excitation light that enters again the first clad 22 from the GRIN lens is combined again with the point A of the first clad 22 and then becomes skew mode light that propagates clockwise which is reverse to the propagation direction of the skew mode light shown in FIG. 4(a).

In the case where the lens length of the GRIN lens is the odd multiple of 0.25 pitch, the excitation light that enters again the first clad 22 from the GRIN lens is combined with a point B which is symmetrical about the point A when the center point is the core 21 in the first clad 22 as shown in FIG. 4(c). In the case where the lens length of the GRIN lens is shorter than the odd multiple of 0.25 pitch, the excitation light that enters again the first clad 22 from the GRIN lens is made incident to a point C which is a little earlier than the point B as shown in FIG. 4(b). In the case where the lens length of the GRIN lens is longer than the odd multiple of 0.25 pitch, the excitation light that enters again the first clad 22 from the GRIN lens is made incident to a point D which is a little later than the point B as shown in FIG. 4(d). In the above examples, the propagation path of the excitation light that enters again the first clad 22 is out of the skew mode.

Therefore, in the case where the sectional shape of the first clad is the regular polygon having M angles (M is an odd number that is equal to or larger than 3), it is possible to prevent the recombination with the skew mode of the excitation light that enters again the first clad 22 from the GRIN lens by so setting the lens length of the GRIN lens as to avoid the integer multiple of 0.5 pitch. The same behavior is observed in the case where the sectional shape of the first clad 22 is the irregular polygon having L angles (L is an integer that is equal to or larger than 3).

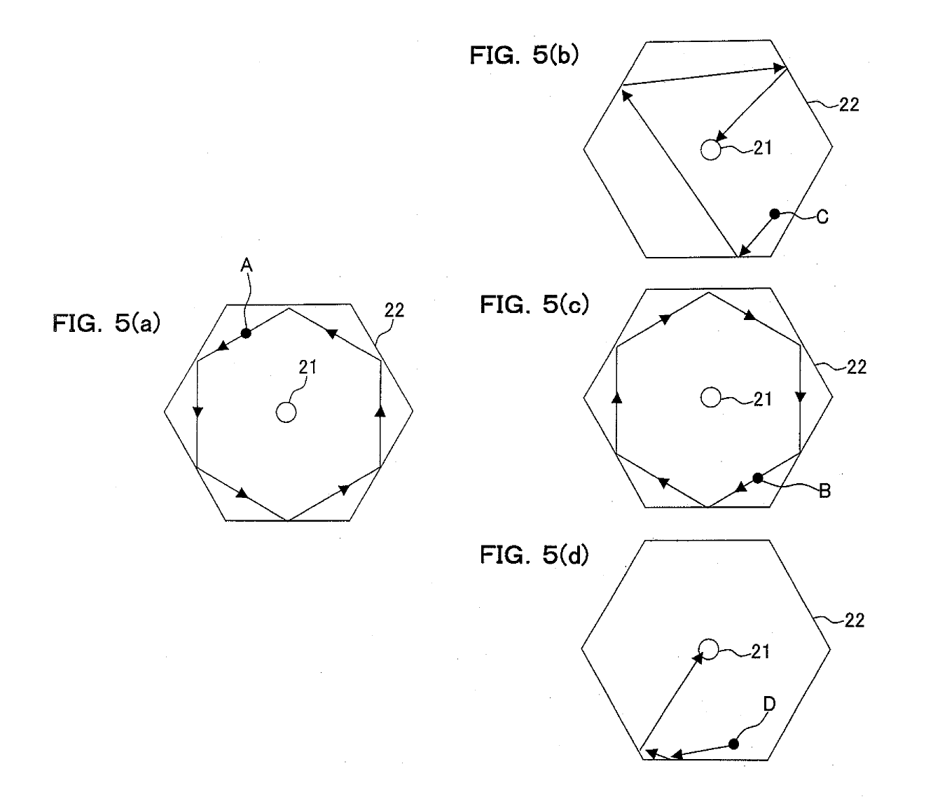

FIGS. 5(a) to 5(d) are second examples of a propagation path of light in skew mode in the case where a sectional shape of the first clad is a regular polygon having N angles (N is an even number that is equal to or larger than 4), wherein FIG. 5(a) is the propagation path before entering a GRIN lens, FIG. 5(b) is the propagation path after entering a GRIN lens having a lens length which is shorter than an odd multiple of 0.25 pitch, FIG. 5(c) is the propagation path after entering a GRIN lens having a lens length which is the odd multiple of 0.25 pitch, and FIG. 5(d) is the propagation path after entering a GRIN lens having a lens length which is longer than the odd multiple of 0.25 pitch. In FIG. 5, the case in which the sectional shape is a regular hexagon-shaped, i.e. N=6, is shown as one example of the regular polygon having N angles.

In the case where the lens length of the GRIN lens is 0.5 pitch, the excitation light that enters again to the first clad 22 from the GRIN lens is combined again with a point A of the first clad 22 and then becomes skew mode light that propagates clockwise which is reverse to the propagation direction of the skew mode light shown in FIG. 5(a).

In the case where the lens length of the GRIN lens is the odd multiple of 0.25 pitch, the excitation light that enters again the first clad 22 from the GRIN lens is combined with a point B which is symmetrical about the point A when the center point is the core 21 in the first clad 22 as shown in FIG. 5(c) and then becomes skew mode light that propagates clockwise which is reverse to the propagation direction of the skew mode light shown in FIG. 5(a).

In the case where the lens length of the GRIN lens is shorter than the odd multiple of 0.25 pitch, the excitation light that enters again the first clad 22 from the GRIN lens is made incident to a point C which is a little earlier than the point B as shown in FIG. 5(b). In the case where the lens length of the GRIN lens is longer than the odd multiple of 0.25 pitch, the excitation light that enters again the first clad 22 from the GRIN lens is made incident to a point D which is a little later than the point B as shown in FIG. 5(d). In the above examples, the propagation path of the excitation light that enters again the first clad 22 is out of the skew mode.

Therefore, in the case where the sectional shape of the first clad is the regular polygon having N angles (N is an even number that is equal to or larger than 4), it is possible to prevent the recombination with the skew mode of the excitation light that enters again the first clad 22 by so setting the lens length of the GRIN lens as to avoid the odd multiple of 0.25 pitch.

In the case where the lens length of the GRIN lens is an integer multiple of 1/N of 0.5 pitch, the propagation path of the excitation light that enters again the first clad 22 is in a skew mode directed to a point defined by rotating the point A by 360/N degrees about the core 21 shown in FIG. 5(c). For example, in the case where the lens length of the GRIN lens is 0.25 pitch which is 3/6 times of 0.5 pitch, the propagation path is in a skew mode directed to a point defined by rotating the point A by 180° about the core 21 shown in FIG. 5(c). In the case where the lens length of the GRIN lens is 0.42 pitch which is ⅚ times of 0.5 pitch, the propagation path is in a skew mode directed to a point defined by rotating the point B anticlockwise by 60° about the core 21 shown in FIG. 5(c). In the case where the lens length of the GRIN lens is 0.58 pitch which is 7/6 times of 0.5 pitch, the propagation path is in a skew mode directed to a point defined by rotating the point B clockwise by 60° about the core 21 shown in FIG. 5(c).

Therefore, in the case where the sectional shape of the first clad is the regular polygon having N angles (N is an even number that is equal to or larger than 4), it is possible to prevent the recombination with the skew mode of the excitation light that enters again the first clad 22 from the GRIN lens by so setting the lens length of the GRIN lens as to avoid the integer multiple of 1/N of 0.5 pitch.

### EXAMPLES

A comparative experiment was conducted on reliability of the fiber laser according to the present embodiment.

As the rare earth-doped optical fiber 11 shown in FIG. 1, a double clad fiber having a first clad and a second clad in this order from a core was used. The first clad had a diameter of 400 μm, a NA of 0.46, and a hexagonal sectional shape of N=6. The second clad was a resin clad. By using a fuse-bonding device using a CO₂ laser as a heat source, the rare earth-doped optical fiber 11 and the GRIN lens 12 were coaxially fuse-bonded.

The GRIN lens 12 had an effective diameter of φ5 mm, was made from silica, and had a lens length of 0.26 which is equivalent to an odd multiple of 0.25 pitch ±0.01 pitch. Thus, the lens length of the GRIN lens 12 was decided by avoiding 0.25 pitch which is an odd multiple of 1/N of 0.5 pitch.

In contrast, as Comparative Example, a configuration in which amplified light is emitted without entering the GRIN lens 12 was prepared by providing a reflection filter directly on an beam emission end of the rare earth-doped optical fiber 11 according to Example. Even in comparative Example, an AR coating was formed on the emission end of the rare earth-doped optical fiber 11 as a reflection filter.

In each of the fiber lasers according to Example and Comparative Example, amplified light having an average intensity of 75 kW/mm² was emitted from the rare earth-doped optical fiber 11. As a reflection filter to be provided on an end face of the GRIN lens 12, an AR coating formed of a dielectric multilayer film having properties of maintaining transmission ratio of light having a wavelength shorter than 990 nm to 0.1% or less and a transmission ratio of light having a wavelength longer than 1040 nm to 98% or more was formed directly on the end face. Also, in order to ensure to form an oscillator between reflection mirrors 15a and 15b, a reflection mirror having a reflection ratio of 10% was used as the reflection mirror 15b.

As a result, the reflection filter that was provided in the rare earth-doped optical fiber 11 in Comparative Example was burnt with high probability of 90% or more.

In contrast, an average intensity of the amplified light emitted from the reflection filter provided on the GRIN lens 12 was 750 kW/mm² or less in Example. Thus, it was possible to reduce a power density of the amplified light at the beam emission end from the GRIN lens 12 to 1/100 of the average intensity at the emission end of the rare earth-doped optical fiber 11. Therefore, any damage on the reflection filter provided on the GRIN lens 12 did not occur in Example.

The AR coating formed of dielectric multilayer film ordinarily has a 3-layer structure or a 4-layer structure, but about 50 layers are required for a long wavelength transmitting filter. Though a high power property of the dielectric multilayer film is reduced along with an increase in number of layers, it is possible to maintain the high power property by using the configuration according to Example even in the case where the number of layers is increased. Therefore, it is confirmed that reliabilities of the optical fiber emission circuit and the fiber laser were greatly improved by implementing the configuration according to the present embodiment.

In Comparative Example, apart in which a temperature near a beam output end locally exceeded 150° C. due to unavailable excitation light was detected. In contrast, it was possible to suppress a temperature near a beam output end of the GRIN lens 12 to 60° C. or less in Example. Therefore, it is confirmed that adverse influences such as a reduction of life and burnout of a component part near the beam output end of the GRIN lens 12 were prevented by implementing the configuration according to the present embodiment.

It was possible to improve conversion efficiency from the excitation light to the amplified light to 67% to 69% by implementing the configuration of the fiber laser according to Example. It is confirmed that, by the rare earth-doped optical fiber 11 in which a sectional shape of the first clad was a polygon having N angles, avoiding to set a lens length of the GRIN lens 12 to an integer multiple of 1/N of 0.5 pitch, and setting the lens length to an odd multiple of 0.25 pitch ±0.01 pitch, recombination of the excitation light that entered again the rare earth-doped optical fiber 11 with the skew mode was prevented, and that the unavailable excitation light was efficiently reused.

### INDUSTRIAL APPLICABILITY

Owing to the capability of being used for processing because of the high output of the fiber laser, the present invention is applicable to a wide range of industries including electric appliance industry and general machinery industry.

### DESCRIPTION OF REFERENCE NUMERALS

11: rare earth-doped optical fiber
12: GRIN lens
13: excitation light source
14: excitation light combiner
15a, 15b: reflection mirror
21: core
22: first clad
23: coating
24: reflection filter

1. An optical fiber emission circuit comprising:
a rare earth-doped optical fiber that has a plurality of layers of clads around a core and emits radiation light having a wavelength longer than a wavelength of excitation light when the excitation light is made incident thereto and
a GRIN (Graded-Index) lens that is fuse-bonded to an end face of the rare earth-doped optical fiber and has a refractive index distribution in a radial direction, wherein
the GRIN lens has a lens length that is a value except for an integer multiple of 0.5 pitch and is provided with a reflection filter that is disposed at an open end part in an axial direction and selectively reflects the wavelength of the excitation light.

2. The optical fiber emission circuit according to claim 1, wherein the lens length of the GRIN lens is within a range of an odd multiple of 0.25 pitch ±0.15 pitch.

3. The optical fiber emission circuit according to claim 1, wherein a sectional shape of a first clad among the plurality of layers of clads contacting the core is an irregular polygon having L angles (L is an integer that is equal to or larger than 3) or a regular polygon having M angles (M is an odd number that is equal to or larger than 3).

4. The optical fiber emission circuit according to claim 1, wherein
a sectional shape of a first clad among the plurality of layers of clads contacting the core is a regular polygon having N angles (N is an even number that is equal to or larger than 4), and
the GRIN lens has a lens length that is a value except for an integer multiple of 1/N of 0.5 pitch.

5. The optical fiber emission circuit according to claim 1, wherein the lens length of the GRIN lens is within a range of an odd multiple of 0.25 pitch ±0.03 pitch.

6. The optical fiber emission circuit according to claim 1, wherein the lens length of the GRIN lens is within a range of an odd multiple of 0.25 pitch ±0.02 pitch.

7. A fiber laser comprising:
the optical fiber emission circuit defined in claim 1;
an excitation light source that supplies the excitation light to the optical fiber emission circuit; and
a pair of reflection mirrors that are disposed at two distant points in the rare earth-doped optical fiber and generates laser oscillation of the excitation light from the excitation light source.

8. The optical fiber emission circuit according to claim 2, wherein a sectional shape of a first clad among the plurality of layers of clads contacting the core is an irregular polygon having L angles (L is an integer that is equal to or larger than 3) or a regular polygon having M angles (M is an odd number that is equal to or larger than 3).

9. The optical fiber emission circuit according to claim 2, wherein
a sectional shape of a first clad among the plurality of layers of clads contacting the core is a regular polygon having N angles (N is an even number that is equal to or larger than 4), and
the GRIN lens has a lens length that is a value except for an integer multiple of 1/N of 0.5 pitch.

10. The optical fiber emission circuit according to claim 3, wherein the lens length of the GRIN lens is within a range of an odd multiple of 0.25 pitch ±0.03 pitch.

11. The optical fiber emission circuit according to claim 4, wherein the lens length of the GRIN lens is within a range of an odd multiple of 0.25 pitch ±0.03 pitch.

12. The optical fiber emission circuit according to claim 3, wherein the lens length of the GRIN lens is within a range of an odd multiple of 0.25 pitch ±0.02 pitch.

13. The optical fiber emission circuit according to claim 4, wherein the lens length of the GRIN lens is within a range of an odd multiple of 0.25 pitch ±0.02 pitch.

14. A fiber laser comprising:
the optical fiber emission circuit defined in claim 2;
an excitation light source that supplies the excitation light to the optical fiber emission circuit; and
a pair of reflection mirrors that are disposed at two distant points in the rare earth-doped optical fiber and generates laser oscillation of the excitation light from the excitation light source.

15. A fiber laser comprising:
the optical fiber emission circuit defined in claim 3;
an excitation light source that supplies the excitation light to the optical fiber emission circuit; and
a pair of reflection mirrors that are disposed at two distant points in the rare earth-doped optical fiber and generates laser oscillation of the excitation light from the excitation light source.

16. A fiber laser comprising:
the optical fiber emission circuit defined in claim 4;
an excitation light source that supplies the excitation light to the optical fiber emission circuit; and
a pair of reflection mirrors that are disposed at two distant points in the rare earth-doped optical fiber and generates laser oscillation of the excitation light from the excitation light source.

17. A fiber laser comprising:
the optical fiber emission circuit defined in claim 5;
an excitation light source that supplies the excitation light to the optical fiber emission circuit; and
a pair of reflection mirrors that are disposed at two distant points in the rare earth-doped optical fiber and generates laser oscillation of the excitation light from the excitation light source.

18. A fiber laser comprising:
the optical fiber emission circuit defined in claim 6;
an excitation light source that supplies the excitation light to the optical fiber emission circuit; and
a pair of reflection mirrors that are disposed at two distant points in the rare earth-doped optical fiber and generates laser oscillation of the excitation light from the excitation light source.

19. A fiber laser comprising:
the optical fiber emission circuit defined in claim 8;
an excitation light source that supplies the excitation light to the optical fiber emission circuit; and
a pair of reflection mirrors that are disposed at two distant points in the rare earth-doped optical fiber and generates laser oscillation of the excitation light from the excitation light source.

20. A fiber laser comprising:
the optical fiber emission circuit defined in claim 9;
an excitation light source that supplies the excitation light to the optical fiber emission circuit; and
a pair of reflection mirrors that are disposed at two distant points in the rare earth-doped optical fiber and generates laser oscillation of the excitation light from the excitation light source.
